(19) United States
(12) Patent Application Publication
(10) Pub. No.: US 2014/0353433 A1
(43) Pub. Date: Dec. 4, 2014

(54) ROTORCRAFT FLIGHT CONTROL STICK TILTABLY MOUNTED ON A SUPPORT BY A FLEXIBLE ROD WITH A FIXED END

(71) Applicant: AIRBUS HELICOPTERS, Marignane (FR)

(72) Inventors: Bernard GEMMATI, Lauris (FR); Brice LEBERNICHEUX, Rennes (FR); Jean-Evrard BRUNEL, Montreal (CA)

(73) Assignee: AIRBUS HELICOPTERS, Marignane (FR)

(21) Appl. No.: 14/288,781

(22) Filed: May 28, 2014

(30) Foreign Application Priority Data
Jun. 3, 2013 (FR) 13 01250

(51) Int. Cl. B64C 27/56; B64C 27/58

(52) U.S. Cl. CPC B64C 27/56; B64C 27/58
USPC 244/234

(57) ABSTRACT

A fly-by-wire control mechanism for a rotorcraft, the mechanism comprising a stick (1) hinged to tilt in multiple directions on a support (2), detector means (6) for detecting the tilting position of the stick (1) and generating electrical signals (7), and force feedback means providing the pilot with a sensation of forces (12) opposing tilting of the stick (1). The stick (1) includes a rod (13) having its distal end held in fixed manner in the support (2), while providing a movable mount for the stick (1) on the support (2). Causing the stick (1) to tilt leads to flexing of the rod (13) from its anchor zone (16) in the support (2), with the resistance of the rod (13) to flexing deformation serving to develop the opposing forces (12) and also being measured in order to generate the electrical signals (7).

### CROSS REFERENCE TO RELATED APPLICATION

This application claims priority to French patent application No. FR 13 01250 filed on Jun. 3, 2013, the disclosure of which is incorporated in its entirety by reference herein.

### BACKGROUND OF THE INVENTION

(1) Field of the Invention

The present invention relates to the field of rotorcraft and more specifically to flight control members operated by a human to cause the pitch of the blades of a main rotor of substantially vertical axis of a rotorcraft to vary cyclically for the purpose of modifying the attitude in flight of the rotorcraft in pitching and in roll.

(2) Description of Related Art

The present invention relates to such flight control members that are typically arranged as sticks (or joysticks) hinged to tilt in multiple directions on a support that may be arranged as a box. The present invention thus lies within the context of such sticks arranged to issue electrical flight commands (i.e. sticks constituting fly-by-wire controls (FBW)) under the effect of the stick being tilted by a human.

Rotorcraft are rotary wing aircraft in which at least lift is provided by at least one main rotor of substantially vertical axis. In the specific context of a helicopter, the main rotor provides the rotorcraft not only with lift but also with propulsion to advance in any direction. The attitude of a helicopter in flight can also be modified by a pilot of the rotorcraft varying the cyclic and/or collective pitch of the blades making up the rotary wing of the main rotor.

Rotorcraft are also fitted with antitorque devices serving to guide them in yaw, such as at least one auxiliary rotor having a substantially horizontal axis. Such an auxiliary rotor may for example be a tail rotor or it may be formed by at least one propulsive propeller in a helicopter having high speed propulsion. The yaw attitude of the rotorcraft can be stabilized under the control of a pilot of the rotorcraft varying the collective pitch of the blades of at least one auxiliary rotor of the rotorcraft.

A human pilot of the rotorcraft has various flight control members that can be moved by a human in order to vary the pitch of the blades of the rotor(s) of the rotorcraft.

Conventionally, for an auxiliary rotor, the collective pitch of the blades is controlled by a human acting on pedals.

For a main rotor, collective variation in the pitch of the blades is conventionally controlled by a human acting on a lever that is hinged to move both ways along a single tilt direction. The cyclic pitch of the blades of the main rotor is varied by a human acting on a stick hinged to move both ways along each of two mutually orthogonal tilt directions, thereby enabling the attitude of the rotorcraft to be modified respectively in pitching and in roll.

Nevertheless, it is not impossible for the collective pitch of the blades of the main rotor or of the auxiliary rotor to be varied by a human using a stick that is hinged to tilt, in particular in the context of fly-by-wire controls.

The flight control members are connected to the blades of a rotor corresponding thereto via at least one drive train. The human pilot acting on a flight control acts via at least one said drive train to cause the blades to pivot about their respective pitch axes.

Such drive trains are commonly classified either as mechanical flight control drive trains or “linkages”, or else as fly-by-wire control systems.

With a mechanical flight control linkage, the pilot moving the flight control member causes the pitch of the blades to be varied by means of a mechanical linkage transmitting movements from the flight control member to the blades that are to be operated.

With fly-by-wire control systems, the pilot moving the flight control member causes electrical signals to be generated that are used by at least one calculation means for driving variation in the pitch of the blades. Conventionally, position sensors detect a change in the position of the flight control member and generate electrical signals as a function of the variation in the position of the flight control member. The electrical signals are transmitted to the calculation means which convert them into commands to be executed by at least one actuator for varying the pitch of the blades. Such actuators are commonly referred to as a “trim” actuator and as a “series” actuator.

For example, Document U.S. Pat. No. 3,331,971 (Waldemar Moller) describes a fly-by-wire control stick that is “stiff”, i.e. its distal end is anchored in fixed manner to a support. The flexing movements of the stick operated by the pilot are detected by magnetic means delivering electrical signals to calculation means that generate commands for causing the actuators to operate.

Numerous advantages are obtained by making use of fly-by-wire controls.

For example, the fly-by-wire control members used for generating control signals can be arranged in a compact manner in order to limit the space they occupy, and thus make it easier to install them on board the aircraft. In particular, when the sticks that generate control signals are small in size, they can easily be installed in the armrest of a seat on which the pilot sits on board the rotorcraft.

The mechanical structure movably mounting a flight control member that generates electric control signals may be simple and light in weight, so the forces to which a control member are subjected for generating the electric control signals are limited essentially to being moved by a human.

Also by way of example, using fly-by-wire controls enables complex piloting relationships to be implemented, such as relationships for piloting in terms of a target to be achieved, thus enabling a large number of electrical control functions to be grouped together on a single flight control member.

In addition, using fly-by-wire controls is comfortable for the pilot because of the disconnect in the drive train between the efforts made by the pilot in order to generate the electrical signals by moving the flight control member, and the motor-driven forces developed by the actuator(s) in order to drive the variation in the pitch of the blades.

Nevertheless, an advantage in mechanical flight controls lies in the possibility of using the linkage to return a sensation to the human pilot via the flight control member, which sensation is representative of the forces being developed to drive variation in the pitch of the blades.

There thus arises the problem of ensuring that the pilot has such a force feedback sensation in the context of using fly-by-wire controls. For this purpose, the flight control members that generate control signals are conventionally engaged on members that are elastically deformable so as to oppose elastic resistance against the pilot moving the flight control member.

It is also known to make use of electric motors to generate such force feedback. Such electric motors generate resistance to the pilot moving the flight control member for generating control signals as a function of the movements that the pilot applies to the member.

In the context of sticks used for controlling variation in the attitude of a rotorcraft, e.g. in pitching and in roll, or indeed possibly in yaw or even vertically, such a stick is generally in the form of a handle fitted to the proximal end of a rod having its opposite distal end hinged via a ball joint to a box. The ball joint hinging of the rod on the box allows the stick to tilt in multiple directions about the center of the ball joint so as to move both ways along said two mutually orthogonal tilting directions.

For example, with a stick that is used for controlling attitude variation in pitching and in roll, front-to-rear tilting of the stick conventionally guides the rotorcraft in pitching, while right-to-left tilting of the stick guides the rotorcraft in roll. The concepts of front, rear, right, and left should be considered relative to the situation of the pilot manipulating the flight control member.

The rod of a control stick that can be tilted in multiple directions can be hinged to the box via a ball joint in a variety of configurations, all of which are complex to a greater or lesser extent.

For example, according to Document DE 198 06 611 (Deutsch Zentre Luft & Raumfahrt) the ball joint hinge is made by means of a sphere provided at the distal end of the rod and mounted to move in a cavity in a box. Also by way of example, according to Document FR 2 643 331 (Aerospatiale), the ball joint hinge is provided by means of at least one cardan type mechanism. Also by way of example, according to Documents FR 2 643 502 (Aerospatiale) and GB 2 377 005 (Caterpillar Inc.), the ball joint hinge is made by mounting the rod free to move in a single direction on a body that is mounted to tilt on the support, the rod and the body moving about respective pivot axes that intersect.

For the force feedback devices that are associated with flight control sticks, reference may be made for example to above-mentioned Documents FR 2 643 331 and FR 2 643 502. In Document FR 2 643 331, a force feedback device is made up of elastically deformable members, such as compression springs, interposed between the stick and the support along the respective movement axes of the stick. In Document FR 2 643 502, a force feedback device is made up of electric motors engaged on the stick and actuated by calculation means making use of the electrical signals generated by the stick under the effect of the stick being moved by the pilot.

Still concerning force feedback devices, reference may also be made to Document U.S. Pat. No. 4,477,043 (D. W. Repperger) which proposes hinging the stick via a ball joint on a support and providing a force feedback device at its distal end. According to U.S. Pat. No. 4,477,043, the force feedback device is formed by springs that are compressed to a greater or lesser extent by a motor-driven wormscrew type mechanism, with the activation of said mechanism depending on calculation means that identify the tilt position of the stick used for generating flight control signals.

It is also known from Document FR 2 962 973 (Airbus Operations SAS) to fit a flight control stick with a force feedback device making use of actuators that oppose tilting of the stick by means of angle transmission mechanisms.

It can be seen that the ways in which a flight control stick for generating control signals is mounted in a rotorcraft remain structurally complex and could advantageously be simplified.

More particularly, the drawbacks of mechanisms in general lie in the risks of the moving members they include seizing, and also lie in the operating clearances that tend to affect the accuracy with which said moving members are moved. Furthermore, it is industrially advantageous to simplify the structural organization of a mechanism in order to reduce as much as possible the costs of making it and of maintaining it.

It is therefore useful to reduce as much as possible the number of members making up a mechanism in general and to simplify its structural organization, while seeking solutions that are industrially and economically satisfactory for avoiding the above-mentioned drawbacks. Such utility is to be sought in a flight control mechanism for a rotorcraft making use of a stick that generates control signals and that is hinged on a support to tilt in multiple directions.

Nevertheless, structurally simplifying such a flight control mechanism must not damage the operating reliability of the stick. Such operating reliability relates in particular to the desired accuracy for movement of the stick having various potential positions that are detected for the purpose of causing the blades of a rotorcraft rotor to pivot about their respective pitch axes.

In addition, structurally simplifying a flight control mechanism must not ignore the various functions that are useful or even essential in the use of the stick, in particular concerning arrangements that provide the pilot with said force feedback. Furthermore, it is appropriate to take advantage of the desired structural simplification in the way the stick is mounted to simplify such arrangements also.

The stick may additionally incorporate various and numerous auxiliary control members, such as control buttons, for example. The looked-for simplification in the flight control mechanism must nevertheless leave open the option of installing auxiliary control members, and should indeed preferably make it easier firstly to install such auxiliary control members on the stick, and secondly to facilitate assembly and maintenance operations involving them.

### BRIEF SUMMARY OF THE INVENTION

The object of the present invention is to provide a fly-by-wire control mechanism for a rotorcraft to vary the pitch of the blades of at least one rotor of the rotorcraft, such as a main rotor of substantially vertical axis and/or an auxiliary rotor of substantially horizontal axis. Said mechanism is of the type comprising a fly-by-wire control mechanism for a helicopter and it essentially comprises:

a stick hinged to tilt in multiple directions on a support via a rod;

detector means for detecting the tilt position of the stick when moved by a human, for the purpose of generating electrical signals that are used by calculation means to vary the pitch of said blades; and

force feedback means acting via the stick to provide the pilot with a sensation of forces opposing tilting movement of the stick.

In this context, the present invention seeks more particularly to propose such a fly-by-wire control mechanism for a rotorcraft that takes account of the constraints, the difficulties to be overcome, and the looked-for advantages as mentioned above.

Such a fly-by-wire control mechanism of the present invention for a rotorcraft comprises:

a stick hinged on a support to tilt in multiple directions about a center of motion of the stick on the support. The stick includes an axially elongate rod provided at its proximal end with socket means for receiving a handle and at its opposite, distal end with means for movably mounting it on the support.

detector means for detecting the tilt position of the stick moved by the human, in particular the pilot of the rotorcraft. Depending on the tilt position of the stick, said detector means generate electrical signals used by the calculation means for generating commands to be executed by at least one actuator. Depending on the commands it receives, such an actuator causes said blades to pivot about their respective pitch axes in order to vary their pitch, in particular cyclically or collectively.

force feedback means generating opposing forces countering the human forces applied to tilting the stick so as to provide the human with a sensation of said opposing forces via the stick.

The concepts of “proximal” and “distal” should be understood as relating to the position of a member being closer to, or conversely further from, a common frame of reference. In an ergonomic context and more specifically with the stick, said common frame of reference is the human operating the stick via its handle. For example, the proximal end of the rod is thus understood as being the end situated axially closer to the handle while the distal end of the rod is thus understood as being its end situated axially closer to the support.

The concept of “axial” should clearly be considered along the general direction or the axis along which the rod extends generally, said rod being understood to be an axially elongate member. The concept of “transverse” should be understood relative to the concept of “axial”, a transverse direction commonly being defined as intersecting an axial direction. For example, with the rod, a cross-section of the rod, i.e. a section in a transverse direction, is oriented orthogonally relative to its axial section.

According to the present invention, such a fly-by-wire control mechanism is mainly recognizable in that the stick is mounted to move on the support to tilt in multiple directions by having an anchor zone of the rod provided at its distal end held in fixed manner in the support. Tilt movement of the stick gives rise to overall flexing of the rod from its anchor zone towards its proximal end.

The means for mounting the stick to move in tilting on the support are structurally limited to said rod being held in fixed manner in the support. The arrangement of the means for mounting the rod to move on the support are simplified as much as possible, without harming the accuracy obtained in the titling of the stick about said center of motion, since said tilting is obtained by the intrinsic ability of the rod to deform in flexing from its anchor zone under the effect of the human moving the stick.

Furthermore, the intrinsic resistance of the rod to deforming in flexing is advantageously used for forming said force feedback means, at least from the simple structural connection of the rod being held in fixed manner in the support.

Furthermore, the detector means may be limited to one or more force sensors for measuring the forces to which the rod is subjected under the effect of being deformed in flexing.

It can thus be seen, overall, that the structural organization of the mechanism of the present invention is simplified without harming the effectiveness and the accuracy of the flight control signals issued by tilting the rod relative to the center of motion.

The rod is preferably held in fixed manner in the support by embedding the distal end of the rod in a mass of the support. It is possible to use other analogous solutions for holding in fixed manner, such as making use of means for firmly securing the distal end of the rod to the support so as to obtain a robust connection between them. Such securing means may potentially be of the type involving cementing or of the type using co-operating fastener members fitted respectively to the distal end of the rod and to the support.

As mentioned above, the force feedback means advantageously rely on the intrinsic resistance of the rod to deforming in flexing, said opposing forces being developed by the rod opposing its own deformation in flexing under the effect of a human moving the handle.

Preferably, the flexing stroke of the rod is limited by at least one abutment member (stop member) arranged transversely at a distance around the rod. Said at least one abutment member defines an envelope surface around the rod and running from said anchor zone, which envelope surface flares towards the proximal end of the rod, said envelope surface defining an authorized flexing stroke for the rod.

Said at least one abutment member may be restricted to a bearing point co-operating with the anchor zone of the rod on the support to define a generator line for defining the envelope surface, in particular when the envelope surface is a surface of revolution. A plurality of abutment members, each restricted to a respective bearing point, may be aligned along a said generator line that may define together and in association with the anchor zone of the rod on the support.

Said envelope surface should naturally be understood as being defined as surrounding the rod at a distance from the general axis along which it extends. For example, said envelope surface is a surface of revolution, and more particularly a surface of conical shape.

Nevertheless, it should be understood that said envelope surface may be defined by a plurality of bearing members defining respective sections of arbitrary shape for the envelope surface. Such an arbitrary shape for the section of the envelope surface may be determined in particular depending on the flexing stroke that is authorized for the rod as a function of the direction in which it is tilting.

It should also be considered that the shape of the section of the envelope surface may vary along the general axis along which the rod extends, being defined by a plurality of said generator lines that may potentially have a wide variety of individual shapes.

In this context, the force feedback means advantageously include said at least one abutment member. The rod bearing transversely against the abutment member gives rise to localized bending of the rod, thereby modifying the magnitude of the opposing forces that it develops by modifying the axial position of the point where transverse thrust is applied to the rod relative to the position of the anchor zone of the rod.

Potentially, the flexing stroke of the rod is limited by a plurality of said abutment members individually defining respective bending points of at least one generator line defining the shape of the envelope surface, at least locally depending on the orientation of the general axis along which the rod extends.

More particularly, the force feedback means advantageously comprise physically embodying said envelope surface, the shape of the section of the envelope surface potentially varying transversely and/or along the general axis along which the rod extends. Varying the section of the envelope surface makes it possible to vary the force feedback perceived by the pilot as a function of the direction in which the stick is tilted.

In an embodiment that is preferred because of its structural simplicity, said at least one abutment member is provided by a wall shaped to have the shape of said envelope surface. Said wall is placed around the rod at a transverse distance therefrom, forming an enclosure limiting the flexing stroke of the rod.

Potentially, the abutment member may be provided by the wall as a whole, such that a said generator line defining the envelope surface does not have any bending point. The abutment member may also be provided locally on the wall along its axial extension direction by forming a bending point of any said generator line defining the envelope surface.

In another embodiment, said at least one abutment member is movably mounted on the support by adjustment means for adjusting the relative position between the abutment member and the rod. Said adjustment means advantageously constitute means for adjusting the magnitude of the opposing forces developed by the rod, by moving the abutment member to a desired axial position and holding it stationary in that position.

For example, the abutment member may be arranged as a ring locally surrounding the rod somewhere along its axial extension direction. In an embodiment, said ring is arranged as a cursor that is movable along a ramp extending at a transverse distance from the rod and along the rod, the ring being suitable for being held stationary on the ramp at a desired axial and/or transverse position by using blocking means.

It should be considered that said ring may be circular or oblong in shape, or indeed may be of arbitrary shape that is determined depending on the variation desired for the flexing stroke that is to be allowed to the rod as a function of the direction in which it is tilting, in particular for the purpose of varying the feedback force perceived by the pilot as a function of the direction in which the rod is tilted.

In an embodiment, a said abutment member that is arranged as a ring may potentially be carried by a telescopic member extending at a transverse distance from and along the rod and including means for blocking the position in which it is extended, such as a telescopic member arranged as an electric actuator.

As mentioned above, the detector means are advantageously formed by at least one force sensor generating electric voltages that result from the rod deforming under the effect of flexing. Said at least one force sensor is implanted on the rod and generates said electrical signals depending on the magnitudes of said forces that it measures.

By way of example, such a force sensor is constituted by a strain gauge that may be arranged as a transducer.

By way of example, a said force sensor may be installed in the anchor zone of the rod.

In a simple embodiment, the rod is of regular cross-section, and more particularly of circular cross-section. These arrangements are such that the opposing forces developed by the rod are analogous for an envelope surface that is a surface of revolution defined by a single generator line, regardless of the direction in which the stick is tilted about the center of motion for a given level of force used for tilting the stick.

As mentioned above, it is nevertheless possible to envisage varying the magnitude of the opposing forces depending on the direction in which the stick is tilted for modifying the amplitude of the rotorcraft, such as for example respectively in pitching and in roll, or indeed in yaw or vertically.

To this end, the force feedback means potentially use an elliptical shape for the cross-section of the rod. More particularly, the cross-section of the rod may potentially vary in two transverse directions that are mutually orthogonal. These provisions are such that the opposing forces developed by the rod vary as a function of the direction in which the stick is tilted.

In another embodiment, and as mentioned above, the force feedback means include said envelope surface against which the rod, as moved in tilting, comes to bear locally, thereby achieving variation in the opposing forces developed by the rod as a function of the direction in which the stick is tilted.

By way of example, the force feedback means include at least one said abutment member, e.g. a member shaped as a ring. Such a ring may be of regular circular shape or it may be of irregular shape, thereby providing in a single transverse plane a variety of points on which the rod comes to bear against the abutment member, said variety of points being at different respective transverse distances from the rod.

In an embodiment, the stick has at least one elastically deformable mass for damping vibration to which the rod is potentially subjected. Such vibration is generated in particular by the rotorcraft in flight and said elastically deformable mass is arranged to avoid the stick moving in unwanted manner under the effect of such vibration.

For this purpose, said elastically deformable mass is interposed at least in part between the support and the rod, the support being a member via which said vibration is potentially transmitted to the rod.

In a preferred embodiment, at least one elastically deformable mass is formed by a coating made of an elastomer material fitted closely to the outside surface of the rod, in particular by including its anchor zone.

By way of example, the socket means for receiving the handle are arranged as a sleeve into which the handle is engaged at the proximal end of the rod.

The sleeve and the handle are advantageously both open at their distal ends to provide one or more passages for electric cables coming from the handle. Such cables are used in particular for electrically connecting the various auxiliary control members installed on the handle, such as various control buttons that can be actuated by a human holding the handle in one hand.

The support may potentially be arranged as a box for embedding in the armrest of a seat, or it is potentially in the form of a body that is incorporated in said armrest.

### BRIEF DESCRIPTION OF THE SEVERAL VIEWS OF THE DRAWINGS

Embodiments of the present invention are described with reference to the figures of the accompanying sheets, in which:

FIG. 1 is a perspective view of an embodiment of a mechanism of the present invention, comprising a stick installed on an armrest;

FIG. 2 shows the FIG. 1 mechanism, more particularly in axial section of its stick; and

FIG. 3 is a fragmentary axial section view of a stick of a mechanism in a variant embodiment of the present invention.

### DETAILED DESCRIPTION OF THE INVENTION

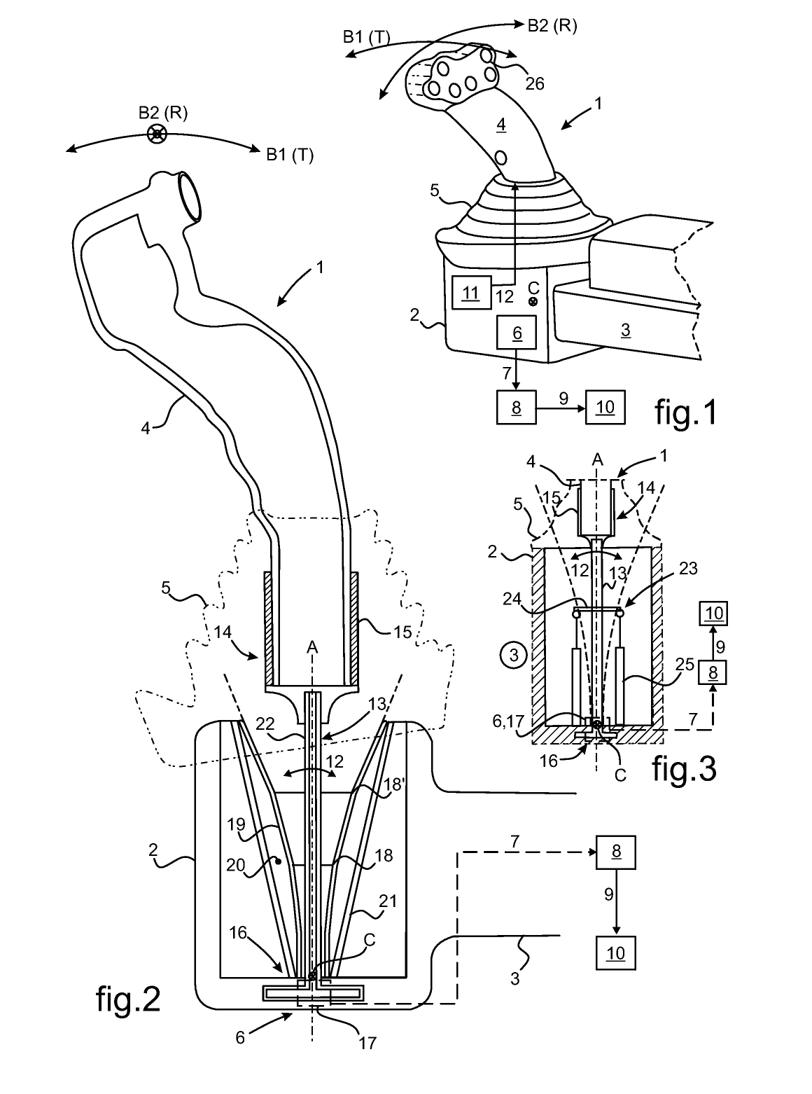

In FIGS. 1 to 3, a fly-by-wire control mechanism for a rotorcraft is organized to vary the pitch of the blades of at least one rotor of the rotorcraft, in particular a main rotor of the rotorcraft having an axis that is substantially vertical, or indeed a tail rotor having an axis that is substantially horizontal. Such a control mechanism typically comprises a stick 1 hinged to tilt in multiple directions on a support 2 about a center of motion C.

The stick 1 is advantageously installed on an armrest 3 of a seat for receiving the pilot on board the rotorcraft. The support 2 is potentially in the form of a body of the armrest 3 that is arranged as a box, or else it is potentially formed by a box that is installed in a body of the armrest 3.

The pilot in position on the seat can tilt the stick 1, which may equally well be installed for the left hand or for the right hand. The stick 1 comprises a handle 4 emerging from the armrest 3 that is to be gripped by the pilot, with the base of the handle 4 typically being surrounded by a flexible protective wall 5 arranged as a bellows covering the support 4.

It should be observed that the handle 4 may potentially be fitted with multiple auxiliary control members 26. Such auxiliary control members 26 enable the pilot to determine various operating setpoints for various members of the rotorcraft.

In the particular embodiment shown, the stick 1 is a control member moved by the pilot to modify the attitude in flight of the rotorcraft in pitching and in roll. It should be understood that such a stick may also be used to vary the collective pitch of the blades of a main rotor of the rotorcraft in order to modify the altitude of the rotorcraft vertically or indeed to vary the collective pitch of the blades of an auxiliary rotor of the rotorcraft in order to modify the attitude of the rotorcraft in yaw. Relative to the situation of a pilot using a hand to move the stick 1:

tilting the stick 1 rearwards or forwards in a first tilting direction B1 serves to vary the attitude of the rotorcraft in pitching T; and

tilting the stick 1 from right to left or left to right in a second tilting direction B2 causes the attitude of the rotorcraft to vary in roll R.

It should naturally be understood that mounting the stick 1 to tilt in multiple directions on the support 2 in conventional manner enables the pilot to point the stick 1 in any tilting direction relative to the center of motion C, with it being possible for the pilot to combine actions on the attitude of the rotorcraft simultaneously both in pitching T and in roll R.

The mechanism conventionally includes detector means 6 for detecting the tilting position of the stick 1. The detector means 6 generate electrical signals 7 depending on the tilting position of the stick 1. Such electrical signals 7 are used by calculation means 8 for generating commands 9 for determining the operation of at least one actuator 10 that serves to move the blades in pivoting about their pitch axes.

The mechanism also conventionally comprises means 11 for providing force feedback, which means generate forces 12 opposing the moving of the stick 1 by the pilot. Such opposing forces 12 provide the pilot, via the stick 1, with a sensation representative of the forces being developed to operate the pivoting of the blades about their pitch axes.

More particularly in FIGS. 2 and 3, the stick 1 has a rod 13 extending along a general axis A and carrying the handle 4 at its proximal end. The rod 13 is preferably made of a metal such as steel.

The proximal end of the rod 13 is provided with socket means 14 for receiving the handle 4. Such socket means 14 are formed by a sleeve 15 for receiving the distal end of the handle 4. The distal end of the handle 4 is open and the bottom of the sleeve 15 is open to allow cables to pass therethrough for making electrical connections with the auxiliary control members 26.

The rod 13 is mounted on the support 2 to move relative thereto in flexing from its distal end. To this end, the rod 13 is mounted on the support 2 by having its distal end held in fixed manner in a mass of the support 2. Such a fixed junction leads to the rod 13 flexing under the effects of tilting drive from the stick 1.

In the embodiments shown, the rod 13 is held in fixed manner in the support 2 by incorporating the distal end of the rod 13 that forms an anchor zone 16 of the rod 13 in a mass of the support 2, i.e. the anchor zone is embedded in the mass of the support 2. By way of example, the anchor zone 16 is formed essentially by an axial shoulder arranged at the distal end of the rod 13, with such an axial shoulder providing a robust fixed connection between the rod 13 and the support 2.

Whatever the direction in which the stick 1 is tilted relative to the center of motion C, the rod 13 is subjected generally to flexing deformation between a spontaneous rest station shown in FIGS. 2 and 3, and a station in which it flexes from its anchor zone 16 towards its proximal end.

In addition, the force feedback means make use of the intrinsic ability of the rod 13 to deform by flexing. When the pilot causes the stick 1 to tilt, the rod 13 flexes and therefore develops said opposing forces 12 that act against the forces applied to the stick 1 by the pilot. The opposing forces 12 developed by the rod 13 enable the pilot to feel the amplitude of the tilting movement that the pilot has imparted to the stick.

The flexing of the rod 13 is also used to generate the electrical signals 7 that are transmitted to the calculation means 8. One or more force sensors 17 are installed on the rod 13 to measure the strains to which it is subjected under the effect of flexing and to generate said electrical signals 7 as a function of the strain measurements performed. In the embodiment shown, such a force sensor 17 is implanted in the anchor zone 16 of the rod 13 on the support 2. Depending on the amplitudes of the measured strains, the force sensor(s) 17 generate(s) the electrical signals 7 that are representative of the flexing of the rod 13 and that are thus representative of the amplitude and the direction of the tilting imparted to the stick 1 by the pilot.

The stroke over which the rod 13 can flex is preferably limited by at least one abutment member 18, 18′, 23 arranged transversely around the rod 13 and at a distance therefrom. The abutment member(s) 18, 18′, 23 act together with the anchor zone 16 to define an envelope surface S arranged around the rod 13 and at a distance therefrom. In the embodiment shown, said envelope surface is a surface of revolution that is flared towards the proximal end of the rod 13, the envelope surface S defining a space in which the rod 13 is free to move in flexing.

Furthermore, the abutment member(s) 18, 18′, 23 make(s) it possible to vary the magnitude of the opposing forces 12 developed by the rod 13 at respective predefined thresholds for the flexing deformation of the rod 13. More particularly, each abutment member(s) 18, 18′, 23 provides a peripheral bearing point for the rod 13, thereby modifying the bending of a generator line defining the shape of the envelope surface S, at least locally, depending on the orientation of the general axis A along which the rod 13 extends.

In the embodiment shown in which the envelope surface is a surface of revolution S, said generator line is a single line and identical in shape for the entire envelope surface S, and in particular it defines a cone flaring towards the proximal end of the rod 13.

It follows that when the rod 13 bears against an abutment member 18, 18′, 23 its flexing deformation bends locally along the axis A along which it extends as a function of its tilt angle and as a function of the forces applied to the stick 1 by the pilot.

In FIG. 2, the flexing stroke of the rod 13 is limited by a wall 19 shaped to match said envelope surface S, where such a shape means that the wall 19 is generally funnel-shaped.

It should be considered that such a funnel may present a shape of potentially arbitrary section depending on the limit desired locally on the flexing stroke of the rod 13 as a function of the direction in which it is tilting. The section of such a funnel may vary in shape both transversely and along the general axis A along which the rod 13 extends. In the embodiment shown in which the envelope surface S presents a conically shaped surface, such a funnel has a section that is circular and of diameter that varies along the general direction in which the axis A of the rod 13 extends.

The wall 19 includes localized bends along the axis A along which the rod 13 extends, where said bends constitute respective abutment members 18, 18′.

The wall 19 is arranged around the rod 13 so as to form an enclosure for confining the rod 13 within a space that is defined by the envelope surface S. By way of example, the wall 19 is placed inside and fastened to a housing 20 of the support 2, which housing is defined by a partition 21. The wall 19 may be fastened by engaging the wall 19 inside the housing 20 and/or by cementing the wall 19 against the support 2.

The rod 13 is also coated with a coating obtained from an elastically deformable mass 22 placed between the support 2 and the rod 13. By way of example, such an elastically deformable mass 22 is made of an elastomer material suitable for absorbing the vibration to which the stick 1 might be subjected. The coating is provided in particular by being overmolded around the rod 13 so as to bond the coating on the rod 13 by vulcanization. Such a coating also provides the rod 13 with protection against the surrounding environment.

In FIG. 3, a said abutment member 23 is formed by a ring 24 surrounding the rod 13 and spaced apart therefrom, at a specific location along the axis A along which the rod 13 extends. The ring 24 is fitted with means 25 for adjusting its position along the axis of the rod 13 in order to adjust its own axial position and thus adjust the magnitude of the opposing forces 12 developed by the rod 13 deformed in flexing. In the embodiment shown, the ring 24 is carried by motor-driven adjustment means 25, such as one or more electric jacks, where operation of such means enables the axial position of the ring 24 along the rod 13 to be adjusted.

What is claimed is:

1. A fly-by-wire control mechanism for a rotorcraft to vary the pitch of blades of at least one rotor of the rotorcraft, the mechanism comprising:
a stick hinged on a support to tilt in multiple directions about a center of motion of the stick on the support, the stick including an axially elongate rod provided at its proximal end with socket means for receiving a handle and at its opposite, distal end with means for movably mounting it on the support;
detector means for detecting the tilting position of the stick, said detector means generating electrical signals depending on the tilting position of the stick, which signals are used by calculation means for generating commands to be executed by at least one actuator that causes said blades to pivot about their pitch axes so as to vary their pitch; and
force feedback means generating opposing forces countering the human forces applied to tilting the stick so as to provide the human with a sensation of said opposing forces via the stick;
wherein the stick is mounted to move on the support to tilt in multiple directions by having an anchor zone of the rod provided at its distal end held in fixed manner in the support, tilting movement of the stick giving rise to overall flexing of the rod from its anchor zone towards its proximal end, the force feedback means comprising the intrinsic resistance of the rod to deforming in flexing, said opposing forces being developed by the rod opposing being deformed in flexing.

2. A mechanism according to claim 1, wherein a flexing stroke of the rod is limited by at least one abutment member arranged transversely at a distance around the rod, said at least one abutment member defining an envelope surface around the rod and running from said anchor zone, which envelope surface that flares towards the proximal end of the rod, said envelope surface defining an authorized flexing stroke for the rod.

3. A mechanism according to claim 2, wherein the force feedback means include said at least one abutment member, the rod bearing transversely against the abutment member giving rise to localized bending of the rod, thereby modifying the magnitude of the opposing forces that it develops.

4. A mechanism according to claim 2, wherein the flexing stroke of the rod is limited by a plurality of said abutment members individually defining respective bending points of a generator line defining said envelope surface.

5. A mechanism according to claim 2, wherein said at least one abutment member is provided by a wall shaped to have the shape of said envelope surface and placed around the rod at a transverse distance therefrom, forming an enclosure limiting the flexing stroke of the rod.

6. A mechanism according to claim 2, wherein said at least one abutment member is movably mounted on the support by adjustment means for adjusting a relative position between the abutment member and the rod, said adjustment means constituting means for adjusting the magnitude of the opposing forces developed by the rod.

7. A mechanism according to claim 1, wherein the detector means are formed by at least one force sensor generating electric voltages that result from the rod deforming under the effect of flexing, said at least one force sensor being implanted on the rod and generating said electrical signals depending on the magnitudes of said forces that it measures.

8. A mechanism according to claim 7, wherein said at least one force sensor is implanted in the anchor zone of the rod.

9. A mechanism according to claim 1, wherein the rod is of circular cross-section.

10. A mechanism according to claim 1, wherein the force feedback means make use of an elliptical shape for a cross-section of the rod so that the opposing forces developed by the rod vary as a function of the tilting direction of the stick.

11. A mechanism according to claim 1, wherein the stick has at least one elastically deformable mass for damping vibration to which the rod is subjected.

12. A mechanism according to claim 11, wherein said at least one elastically deformable mass is formed by a coating made of an elastomer material fitted closely to an outside surface of the rod.

13. A mechanism according to claim 1, wherein the socket means for receiving the handle are arranged as a sleeve into which the handle is engaged at the proximal end of the rod.

14. A mechanism according to claim 1, wherein the support is in the form of a body incorporated in an armrest of a seat.
